(19) United States
(12) Patent Application Publication
(10) Pub. No.: US 2003/0112621 A1
(43) Pub. Date: Jun. 19, 2003

(54) HANGING BUBBLE LAMP

(76) Inventor: Chun Teng Lee, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/020,181

(22) Filed: Dec. 18, 2001

(51) Int. Cl. F21V 33/00

(52) U.S. Cl. 362/96; 362/101; 362/806

(57) ABSTRACT

The present invention relates to a hanging bubble lamp, which includes a conductive receiver with a sleeve to receive a water tube therein and two conductive wires extended downward. The ends of the tube and the sleeve are engaged within a holder, which has two conductive slices to electrically contact with the conductive wires and a heating bulb in a connector in the holder. By used of the conductive, the water tube of the bubble lamp will be kept in a hanging position for providing a special decorative effect.

### BACKGROUND OF THE INVENTION

A conventional bubble lamp, as shown in FIG. 1, includes a holder (1) with an inner bulb (2) and a water tube (3). When the bulb (2) is electrically conducted to light, it produces heat at the same time. The heat will heat water in the tube (3) and when the temperature of water raises to a certain degree, some known medium (31) in the tube (3) will produce bubbles (32) to provide a predicted decorative effect. The prior bubble lamp is always used at a standing position. It can not be used in hanging as shown in FIG. 2, since water will fall at bottom in the tube (3) without contacting with medium (31). There will not be any bubble produced for decoration.

Accordingly, the primary object of the invention is to provide a hanging bubble lamp, which can be hanged by a conductive receiver for providing the water tube having bubbles as in use to display its special decorative purpose. Now the features and advantages of the present invention will be described in detail with reference to the accompanying drawings.

### BRIEF DESCRIPTION OF ACCOMPANYING DRAWINGS

FIG. 1 is a semi cross-sectional plan view showing a known bubble lamp in standing position.

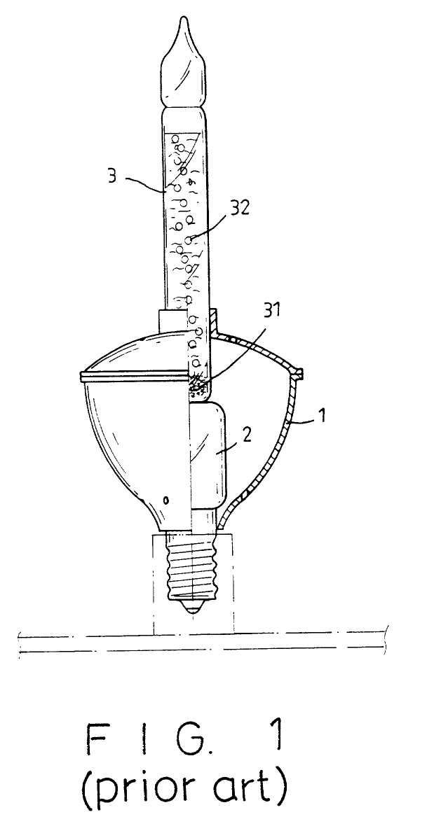

FIG. 2 is a partly cross-sectional plan view showing the known bubble lamp of FIG. 1 in hanging position.

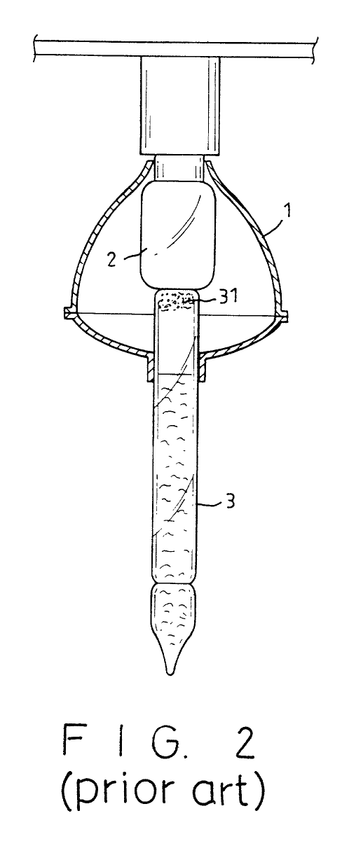

FIG. 3 is an exploded perspective view showing a hanging bubble lamp according to the present invention.

FIG. 4 is a cross-sectional plan view showing an exemplary embodiment of an assembled hanging lamp according to the present invention.

### DETAILED DESCRIPTION OF PREFERRED EMBODIMENTS

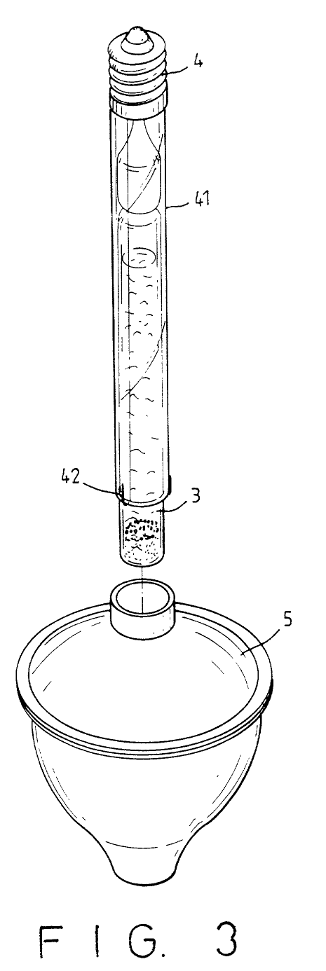

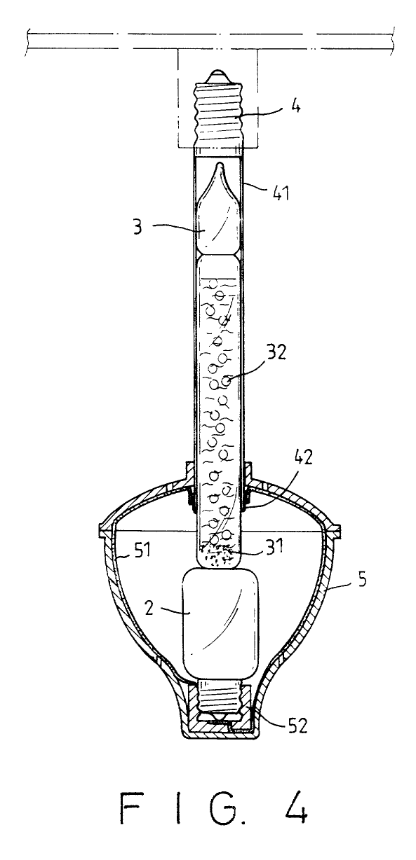

Please refer to FIGS. 3 and 4, the present invention relates to a hanging bubble lamp including a prior water tube (3) and a known heating bulb (2). The characteristic of the present invention includes an improved holder (5) and conductive receiver (4). The conductive receiver (4) has a sleeve (41) to receive the tube (3) and has two conductive wires (42) extended downward with folded end. The lower ends of the tube (3) and the receiver (4) are engaged with the holder (5). The holder (5) is provided with two conductive slices (51), each of which is respectively extended to a different pole of a bulb connector (52) in the holder (5) and is electrically contacted with the heating bulb (2) engaged with the connector (52).

In use, the conductive receiver (4) can be connected with a connector on a lighting string to provide the water tube (3) being at a hanging position. The conductive wire (42) and the conductive slice (51) provide electrical connection for bulb (2) to be heated to heat water in the tube (3) till bubbles (32) are produced to reach the object of the present invention.

Accordingly, the present invention provides an invented structure with improvement, which keeps the bubble lamp to be used in hanging position to produce bubbles for decoration as a known one. It obviously gains the utility and novelty for patent and is thus applied.

What is claimed is:

1. A hanging bubble lamp including a conductive receiver with a sleeve to receive a water tube therein and two conductive wires extended downward, wherein the ends of the tube and the sleeve are engaged within a holder having two conductive slices to electrically contact with the conductive wires and a heating bulb in a connector in the holder.

2. The hanging bubble lamp as claimed in claim 1, wherein the characteristic is in that the conductive receiver is provided above the water tube for keeping the bubble lamp in a hanging position.
